(19) United States
(12) Patent Application Publication
(10) Pub. No.: US 2021/0374543 A1
(43) Pub. Date: Dec. 2, 2021

(54) SYSTEM, TRAINING DEVICE, TRAINING METHOD, AND PREDICTING DEVICE

(71) Applicant: Preferred Networks, Inc., Tokyo (JP)

(72) Inventor: Eiichi MATSUMOTO, Tokyo (JP)

(21) Appl. No.: 17/444,773

(22) Filed: Aug. 10, 2021

Related U.S. Application Data
(63) Continuation of application No. PCT/JP2020/001717, filed on Jan. 20, 2020.

(30) Foreign Application Priority Data
Feb. 14, 2019 (JP) 2019-024823

(51) Int. Cl. G06N 3/08; G06N 3/04; G06K 9/62

(52) U.S. Cl. CPC G06N 3/08; G06K 9/6262; G06K 9/6257; G06N 3/0454

(57) ABSTRACT

A system includes a first neural network configured to calculate, based on input data, data indicative of a predicted result of a predetermined prediction task for the input data, and a second neural network configured to calculate, based on the input data and labelled data corresponding to the input data, data related to error in the labelled data. At least one of the first neural network or the second neural network is trained by using at least both the data indicative of the predicted result calculated by the first neural network and the data related to the error in the labelled data calculated by the second neural network.

### CROSS-REFERENCE TO RELATED APPLICATIONS

This application is a continuation application of International Application No. PCT/JP2020/001717 filed on Jan. 20, 2020, and designating the U.S., which is based upon and claims priority to Japanese Patent Application No. 2019-024823, filed on Feb. 14, 2019, the entire contents of which are incorporated herein by reference.

### BACKGROUND

### 1. Technical Field

The disclosure herein may relate to a system, a training device, a training method, and a predicting device.

### 2. Description of the Related Art

Supervised learning is known as training methods (learning methods) of models in machine learning. In supervised learning, a model is trained using a training data set (a set of combinations of data input into a model and labelled data indicating a correct result predicted in response to the input data being input into the model). The training data set may be referred to as the learning data set.

However, there is a case where labelled data indicates an incorrect answer with respect to true correct answer, and in such a case, the prediction accuracy of a model obtained by training may be reduced. For example, if a model that achieves semantic segmentation is trained, an outline labelled (annotated) to an object in an image, which is the labelled data, may be misaligned with an actual outline of the object (i.e., a true correct answer). As a result the prediction accuracy of the model obtained by training may be reduced.

The present disclosure has been made in view of the above-described point and it is desirable to obtain appropriate training data.

### SUMMARY

According to one aspect of the present disclosure, a system includes a first neural network configured to calculate, based on input data, data indicative of a predicted result of a predetermined prediction task for the input data, and a second neural network configured to calculate, based on the input data and labelled data corresponding to the input data, data related to error in the labelled data. At least one of the first neural network or the second neural network is trained by using at least both the data indicative of the predicted result calculated by the first neural network and the data related to the error in the labelled data calculated by the second neural network.

### BRIEF DESCRIPTION OF THE DRAWINGS

FIG. 1 is a diagram illustrating an example of a functional configuration of a training device according to a first embodiment;

FIG. 2 is a flowchart illustrating an example of a flow of a training process;

FIG. 3 is a diagram illustrating an example of a functional configuration of a training device according to a second embodiment;

FIG. 4 is a diagram illustrating an example of a functional configuration of a training device according to a third embodiment;

FIG. 5 is a drawing illustrating an example of the effect of the present disclosure; and

FIG. 6 is a diagram illustrating an example of a hardware configuration of the training device according to the embodiments.

### DETAILED DESCRIPTION

In the following, each embodiment of the present disclosure will be described in detail with reference to the drawings. In the following embodiments, a training device 10 configured to obtain a trained model having a high prediction accuracy even if labelled data is incorrect with respect to true labelled data will be described.

In the following embodiments, a semantic segmentation is assumed as an example of a task, and a case, in which a trained model that achieves semantic segmentation is obtained, will be mainly described. Thus, in the following, an input image is used as data input into a model, a labelled image is used as labelled data, and a combination of the input image and the labelled image is used as training data. That is, in the present specification, the input data may be referred to as the input image, the labelled data may be referred to as the labelled image, and error of the answer represented by the labelled data may be referred to as the error in the labelled image. Modified labelled data, which will be described later, may be referred to as a modified labelled image.

A labelled image is, for example, an image in which a labelled outline is manually assigned or automatically assigned by a predetermined method to each object in the input image. Here, methods of automatically assigning a labelled outline to an object include, for example, a method of assigning a labelled outline to each object in a photographed image by superimposing, on a photographed image obtained by capturing a real space in which an object is disposed, a CG image obtained by capturing a three-dimensional computer graphic (CG) space in which an object the same as the object in the real space is disposed.

Additionally, in the following embodiments, as the error in the labelled data, it is assumed that a difference between a labelled outline of the object in the labelled image and an actual outline of the object is present. The error in the labelled data may be referred to as the error in the labelled image. In the present specification, the error of the answer represented by the labelled data or the error in the labelled data refers to a difference between the labelled data and the true labelled data. Here, it is difficult to calculate the error in the labelled data in a case where the true labelled data is not obtained. However, in the present disclosure, in order to predict the error from the true labelled data even in a case where the true labelled data is not obtained, the prediction accuracy of a first prediction model that ultimately outputs a prediction is increased by modifying the error in the labelled data by using a second prediction model. It is considered that modification of the error between the labelled data and the true labelled data (i.e., modification of the error in the labelled data) is approximated to modification of the error in the labelled data by using the second prediction model. Additionally, the modification of the labelled data is not limited to a complete modification, and it is only required to modify the error in the labelled data so that the modified labelled data is more favorable than the input labelled data.

If semantic segmentation is assumed, the error in the labelled image indicates, for example, that the outline of the object in the labelled image is misaligned with the actual outline of the object. In the present specification, the misalignment between the outline of the object in the labelled image and the actual outline of the object indicates that the outline in the labelled image is not appropriately set to the actual outline with respect to the same objects, and indicates, for example, that the outline in the labelled image is moved in parallel in any direction relative to the actual outline, or that the outline in the labelled image differs in size from the actual outline. Here, as a result of modifying the position of the outline of the object in the labelled image to be the position of the actual outline, for example, moving the outline in parallel, it is not necessary that the modified outline (e.g., the outline that has been moved in parallel) perfectly matches with the actual outline, and there may be error in the shape of the outline between the outline of the object in the labelled image and the actual outline within a predetermined range. That is, it is only required that the misalignment of the outline in the modified labelled image is more favorable than the misalignment of the outline in the input labelled image.

The following conditions 1 to 4 are assumed, for example, for the error in the labelled image.

Condition 1: the error in the labelled image is within a predetermined range.

Here, a condition that the error is within a predetermined range indicates that if a model is trained by using a combination of the input image and the labelled image as the training data, the training can be performed appropriately, particularly during the training of a data predicting unit 101 in step 15, which will be described later. Additionally, for example, the condition indicates that the prediction accuracy of the trained model is greater than or equal to a predetermined value. The predetermined value differs in accordance with a task achieved by the trained model and an index value of the prediction accuracy, and is set by the user, for example.

Condition 2: the error in the labelled image can be modified by local transformation. Examples of the local transformation include an affine transformation in a local range including the error, a morphing that can be represented by an optical flow, and the like.

Condition 3: there is little skewness in the error in the labelled image used for training. Alternatively, preprocessing that reduces skewness can be performed.

Here, the term “little skewness in the error” indicates that among the labelled images used for training, the error in the labelled image is required to be modified, but there are various errors to the extent where the modification is difficult without using a model. For example, the term indicates that the error randomly occurs (or the occurrence can be regarded as being random).

Condition 4: the error in the labelled image can be modified by using a differentiable function.

The conditions for the labelled images related to the following embodiments are as described above, for example, but the conditions may differ if the disclosure is used for a task other than semantic segmentation.

### First Embodiment

A training device 10 according to a first embodiment will be described in the following.

<Functional Configuration>

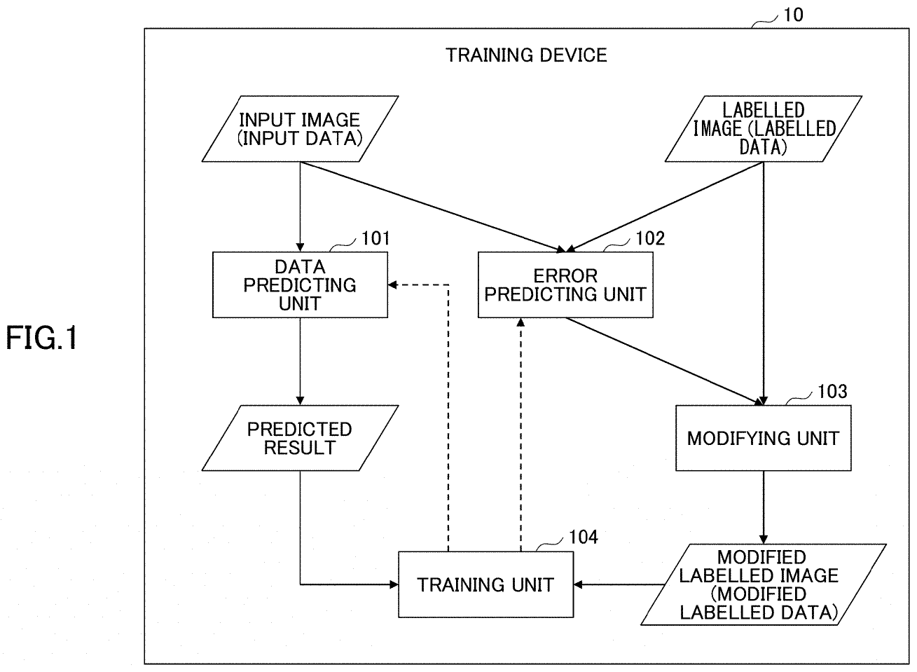

First, a functional configuration of the training device 10 according to the first embodiment will be described with reference to FIG. 1. FIG. 1 is a diagram illustrating an example of the functional configuration of the training device 10 according to the first embodiment.

As illustrated in FIG. 1, the training device 10 according to the first embodiment includes, as functional units, a data predicting unit 101, an error predicting unit 102, a modifying unit 103, and a training unit 104.

The data predicting unit 101 is a neural network model that achieves a predetermined task (e.g., semantic segmentation). A convolutional neural network (CNN) may be used as the neural network model. The data predicting unit 101 outputs, in response to input data (in the present embodiment, an input image) being input, a predicted result (in the present embodiment, data indicative of an outline of each object in the input image and its label).

The error predicting unit 102 is a neural network model that predicts the error in the labelled data (in the present embodiment, the labelled image). A convolutional neural network (CNN) may be used as the neural network model. Here, the labelled data includes information for training that indicates an answer to be ultimately output by inference. The error predicting unit 102 outputs information indicating the degree of the error (hereinafter, also referred to as “error information”) based on the input data and the labelled data.

In the present specification, unless otherwise indicated, “based on the data” includes a case where various data itself is used as an input, and includes a case where any processing is performed on various data, such as a case where an intermediate representation of various data is used as an input.

In the present embodiment, data that can be used to predict the error in the labelled image, that is, for example, information indicating the degree of the error in the labelled image is output in response to the input image, or an intermediate representation from the data predicting unit 101 obtained in response to the input image being input to the data predicting unit 101, and the labelled image, being input (i.e., based on the input data and the labelled data). The error information, for example, indicates which direction and how many pixels, for each object, the outline in the labelled image is moved in parallel relative to the actual outline of a corresponding object. Additionally, the error information may, for example, indicate how long a radius used to rotate the actual outline to align the outline in the labelled image is and how much the actual outline is rotated to align the outline in the labelled image.

The modifying unit 103 outputs a modified labelled image (i.e., modified labelled data) in which the error in the labelled image is modified by the error information, in response to the error information output by the error predicting unit 102 and the labelled image being input (i.e., based on the error information output by the error predicting unit 102 and the labelled data). Here, according to the above-described condition 4, the modifying unit 103 modifies the labelled image based on the error information, for example, by using a predetermined differentiable function.

The training unit 104 calculates, in response to a predicted result output by the data predicting unit 101 and the modified labelled image output by the modifying unit 103 being input (based on the predicted result and the modified labelled data), predictive error between the predicted result and the modified labelled image (i.e., the modified labelled data) by using a predetermined error function. The error function may be referred to as a loss function, an objective function, or the like.

The training unit 104 trains at least one of the data predicting unit 101 or the error predicting unit 102 by using backpropagation based on the calculated predictive error. Here, the training of the data predicting unit 101 indicates, for example, updating parameters of the neural network model implementing the data predicting unit 101. Similarly, the training of the error predicting unit 102 indicates, for example, updating parameters of the neural network model implementing the error predicting unit 102.

<Flow of a Training Process>

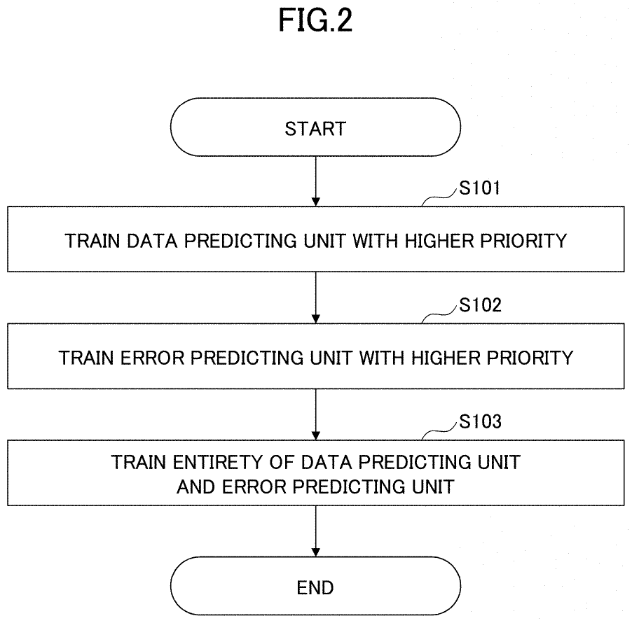

Next, a flow of a process in which the training device 10 according to the first embodiment trains the data predicting unit 101 and the error predicting unit 102 (i.e., a training process) will be described with reference to FIG. 2. FIG. 2 is a diagram illustrating an example of the flow of the training process.

Step S101: first, the training device 10 according to the present embodiment trains the data predicting unit 101 with higher priority in order to obtain a data predictor that can output a predicted result. Here, training the data predicting unit 101 with higher priority indicates, for example, perform a training by setting a learning coefficient λ₁ of a parameter updating equation of the neural network model implementing the data predicting unit 101 to be sufficiently greater than a learning coefficient λ₂ of a parameter updating equation of the neural network model implementing the error predicting unit 102 (i.e., the neural network model included in the error predicting unit 102). In this step, only the data predicting unit 101 may be trained, and the error predicting unit 102 may not be trained (i.e., λ₂=0).

In step S101 described above, in more detail, the following step 11 to step 15 are performed. Step 11, step 12, and step 13 may be performed in no particular order.

Step 11) The data predicting unit 101 outputs a predicted result in response to the input image included in each training data in the training data set provided to the training device 10 being input (based on the input data).

Step 12) The error predicting unit 102 according to the present embodiment outputs the error information in response to the labelled image included in each training data in the training data set provided to the training device 10 and the input image corresponding to the labelled image being input (based on the labelled data and the input data).

Step 13) The modifying unit 103 outputs a modified labelled image in response to the error information and the labelled image corresponding to the error information (that is, the labelled image input to the error predicting unit 102 when predicting the error information) being input (based on the error information and the labelled data).

Step 14) The training unit 104 calculates the predictive error by using a predetermined error function in response to the predicted result and the modified labelled image corresponding to the predicted result (that is, the modified labelled image obtained by modifying the labelled image corresponding to the input image input to the data predicting unit 101 when predicting the predicted result) being input (based on the predicted result and the modified labelled data).

Step 15) The training unit 104 trains the data predicting unit 101 and the error predicting unit 102, for example, by using backpropagation, based on the predictive error calculated in the above-described step 14. At this time, as described above, the training unit 104 trains the data predicting unit 101 and the error predicting unit 102 by setting the learning coefficient λ₁ of the parameter updating expression of the neural network model implementing the data predicting unit 101 to be sufficiently greater than the learning coefficient λ₂ of the parameter updating expression of the neural network model implementing the error predicting unit 102. With the process described above, the data predicting unit 101 that predicts the predicted result (that is, the outline of each object in the input image and its label) with a certain degree of prediction accuracy, can be obtained.

Step S102: next, the training device 10 according to the present embodiment trains the error predicting unit 102 with higher priority. Here, training the error predicting unit 102 with higher priority indicates, for example, performing training by setting the learning coefficient λ2 of the parameter updating equation of the neural network model implementing the error predicting unit 102 to be sufficiently greater than the learning coefficient λ₁ of the parameter updating equation of the neural network model implementing the data predicting unit 101. In this step, only the error predicting unit 102 may be trained, and the data predicting unit 101 may not be trained (i.e., λ₁=0).

In step S102 described above, in more detail, the following steps 21 to 25 are performed. Step 21, step 22, and step 23 may be performed in no particular order.

Step 21) The data predicting unit 101 outputs a predicted result in response to the input image included in each training data in the training data set provided to the training device 10 being input (based on the input data).

Step 22) The error predicting unit 102 outputs the error information in response to the labelled image included in each training data in the training data set provided to the training device 10 and the input image corresponding to the labelled image being input (based on the labelled data and the input data).

Step 23) The modifying unit 103 outputs the modified labelled image in response to the error information and the labelled image corresponding to the error information being input (based on the error information and the labelled data).

Step 24) The training unit 104 calculates the predictive error by using a predetermined error function in response to the predicted result and the modified labelled image corresponding to the predicted result being input (based on the predicted result and the modified labelled data).

Step 25) The training unit 104 trains the data predicting unit 101 and the error predicting unit 102 by using backpropagation, based on the predictive error calculated in the above-described step 24. At this time, as described above, the training unit 104 trains the data predicting unit 101 and the error predicting unit 102 by setting the learning coefficient λ₂ of the parameter updating expression of the neural network model implementing the error predicting unit 102 to be sufficiently greater than the learning coefficient λ₁ of the parameter updating expression of the neural network model implementing the data predicting unit 101. With the process described above, the error predicting unit 102 that predicts the error information with a certain degree of prediction accuracy can be obtained. Even if the prediction accuracy of the data predicting unit 101 that is trained in step S101 is not necessarily high, the error predicting unit 102 can also be trained using the same error function as the error function used to train the data predicting unit 101 because it is expected that a state in which there is no gap between the predicted result and the labelled image (i.e., the labelled data) will be a state in which the error is minimized.

Step S103: finally, the training device 10 according to the present embodiment trains the data predicting unit 101 and the error predicting unit 102 by setting the learning coefficients of both the data predicting unit 101 and the error predicting unit 102 to be low. That is, the training device 10 performs fine tuning on the entirety of the data predicting unit 101 and the error predicting unit 102. Here, for example, setting the learning coefficient to be low indicates that the learning coefficient λ₁ is less than the value used in step S101 and greater than the value used in step S102, and the learning coefficient λ₂ is less than the value used in step S102 and greater than the value used in step S101. These learning coefficients may be identical (i.e., λ₁=λ₂).

In step S103 described above, in more detail, the following steps 31 to 35 are performed. Step 31, step 32, and step 33 may be performed in no particular order.

Step 31) The data predicting unit 101 outputs the predicted result in response to the input image included in each training data in the training data set provided to the training device 10 being input (based on the input data).

Step 32) The error predicting unit 102 outputs the error information in response to the labelled image included in each training data in the training data set provided to the training device 10 and the input image corresponding to the labelled image being input (based on the labelled data and the input data).

Step 33) The modifying unit 103 outputs the modified labelled image in response to the error information and the labelled image corresponding to the error information (based on the error information and the labelled data) being input.

Step 34) The training unit 104 calculates the predictive error by using a predetermined error function in response to the predicted result and the modified labelled image corresponding to the predicted result (based on the predicted result and the modified labelled data) being input.

Step 35) The training unit 104 trains the data predicting unit 101 and the error predicting unit 102 by using backpropagation based on the predictive error calculated by the above-described step 34. At this time, as described above, the training unit 104 trains the data predicting unit 101 and the error predicting unit 102 by setting both the learning coefficient λ₁ of the parameter updating expression of the neural network model implementing the data predicting unit 101 and the learning coefficient λ₂ of the parameter updating expression of the neural network model implementing the error predicting unit 102 to be low. Thus, it is expected that the data predicting unit 101 can be obtained as a trained model that achieves a desired task (e.g., semantic segmentation) with high accuracy.

Here, for example, if the error in each labelled image is extremely small, or if a structure of the model of the neural network implementing the data predicting unit 101 is simple, only step S101 and step S103 may be performed, or only step S103 may be required to be performed to provide an appropriate predicting device.

### Second Embodiment

In the following, a training device 10 according to a second embodiment will be described. In the second embodiment, the difference from the first embodiment will be mainly described, and the description of components substantially the same as the components of the first embodiment will be omitted.

<Functional Configuration>

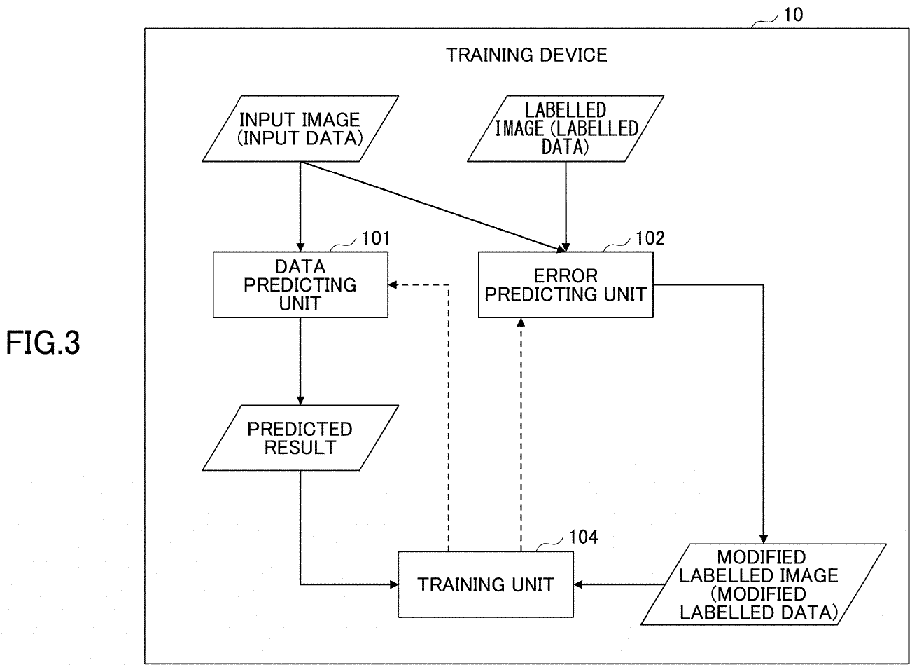

A functional configuration of the training device 10 according to the present embodiment will be described with reference to FIG. 3. FIG. 3 is a diagram illustrating an example of the functional configuration of the training device 10 according to the second embodiment.

As illustrated in FIG. 3, the training device 10 according to the second embodiment includes, as functional units, the data predicting unit 101, the error predicting unit 102, and the training unit 104. That is, the training device 10 according to the second embodiment does not include the modifying unit 103. The data predicting unit 101 and the training unit 104 are substantially the same as those in the first embodiment, and thus the description thereof will be omitted.

The error predicting unit 102 according to the present embodiment outputs the modified labelled image in response to the labelled image and the input image (or an intermediate representation from the data predicting unit 101) being input. That is, the error predicting unit 102 according to the second embodiment is a functional unit in which the error predicting unit 102 and the modifying unit 103 according to the first embodiment are integrally configured.

<Flow of a Training Process>

Next, a training process of the training device 10 according to the second embodiment will be described. The training device 10 according to the second embodiment performs steps S101 to S103 of FIG. 2 as in the first embodiment. However, instead of step 12 and step 13, step 22 and step 23, and step 32 and step 33, the following step 41 is performed.

Step 41) The error predicting unit 102 outputs the modified labelled image in response to the labelled image included in each training data in the training data set provided to the training device 10 and the input image corresponding to the labelled image being input.

### Third Embodiment

In the following, a training device 10 according to a third embodiment will be described. In the third embodiment, the differences between the third embodiment and the first embodiment will be mainly described, and the description of components substantially the same as the components of the first embodiment will be omitted.

<Functional Configuration>

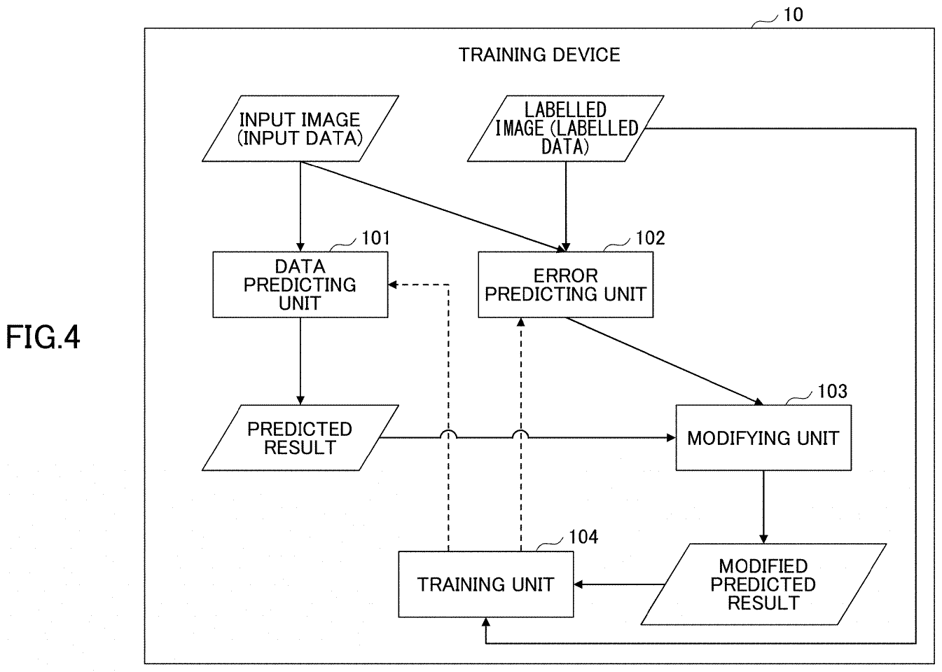

A functional configuration of the training device 10 according to the present embodiment will be described with reference to FIG. 4. FIG. 4 is a diagram illustrating an example of the functional configuration of the training device 10 according to the third embodiment.

As illustrated in FIG. 4, the training device 10 according to the third embodiment includes, as functional units, the data predicting unit 101, the error predicting unit 102, the modifying unit 103, and the training unit 104. The data predicting unit 101 and the error predicting unit 102 are substantially the same as those in the first embodiment, and thus the description thereof will be omitted.

The modifying unit 103 according to the present embodiment outputs a modified predicted result that is modified by using the error information in response to the predicted result output by the data predicting unit 101 and the error information output by the error predicting unit 102 being input. Here, according to the above-described condition 4, the modifying unit 103 modifies the predicted result by using a predetermined differentiable function based on the error information.

The training unit 104 calculates the predictive error between the modified predicted result and the labelled image by using a predetermined error function in response to the modified predicted result output by the modifying unit 103 and the labelled image being input. Then, the training unit 104 trains the data predicting unit 101 and the error predicting unit 102 by using backpropagation based on the calculated predictive error.

<Flow of a Training Process>

Next, a training process of the training device 10 according to the third embodiment will be described. The training device 10 according to the third embodiment performs steps S101 to S103 of FIG. 2 as in the first embodiment. However, instead of step 13 and step 14, step 23 and step 24, and step 33 and step 34, the following step 51 and step 52 are performed.

Step 51) The modifying unit 103 outputs the modified predicted result in response to the error information and the predicted result corresponding to the error information (that is, the predicted result obtained in response to the input image corresponding to the labelled image input to the error predicting unit 102 being input into the data predicting unit 101 when predicting the error information) being input.

Step 52) The training unit 104 calculates the predictive error by using a predetermined error function in response to the modified predicted result and the labelled image corresponding to the modified predicted result (that is, the labelled image corresponding to the input image input to the data predicting unit 101 when predicting the predicted result that is not modified) being input.

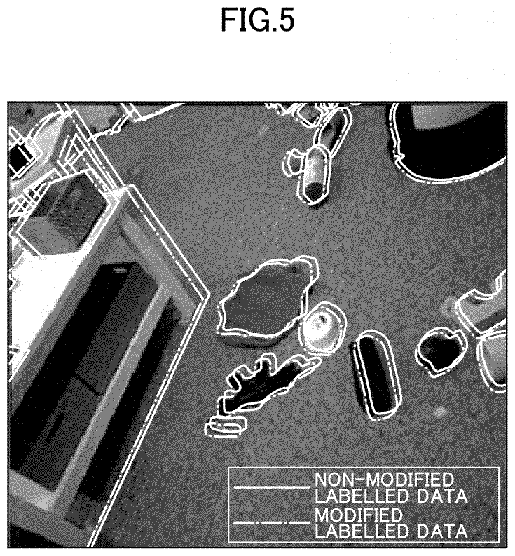

Here, an example in which the error in the labelled image is modified using the error predicting unit 102 trained by the training device 10 according to the first to third embodiments described above is illustrated in FIG. 5. FIG. 5 illustrates, in a case in which an image captured in a room where multiple objects are arranged is used as an input image, an unmodified outline (i.e., unmodified labelled data) of each object in the labelled image corresponding to the input image and a modified outline (i.e., modified labelled data).

As illustrated in FIG. 5, it can be found that for each object in the labelled image, the modified outline is closer to the actual outline of the object. Thus, it can be found that the outline of each object in the labelled image (i.e., the labelled data) has been appropriately modified by the trained error predicting unit 102 (or the trained error predicting unit 102 and the modifying unit 103).

As described, reduction of the prediction accuracy of the predicted result output from the data predicting unit 101 can be suppressed. Further, the data predicting unit 101 obtained by the present embodiment generates the predicted result with high accuracy, and thus the efficiency of the machine learning using the predicted result can be increased.

<Hardware Configuration>

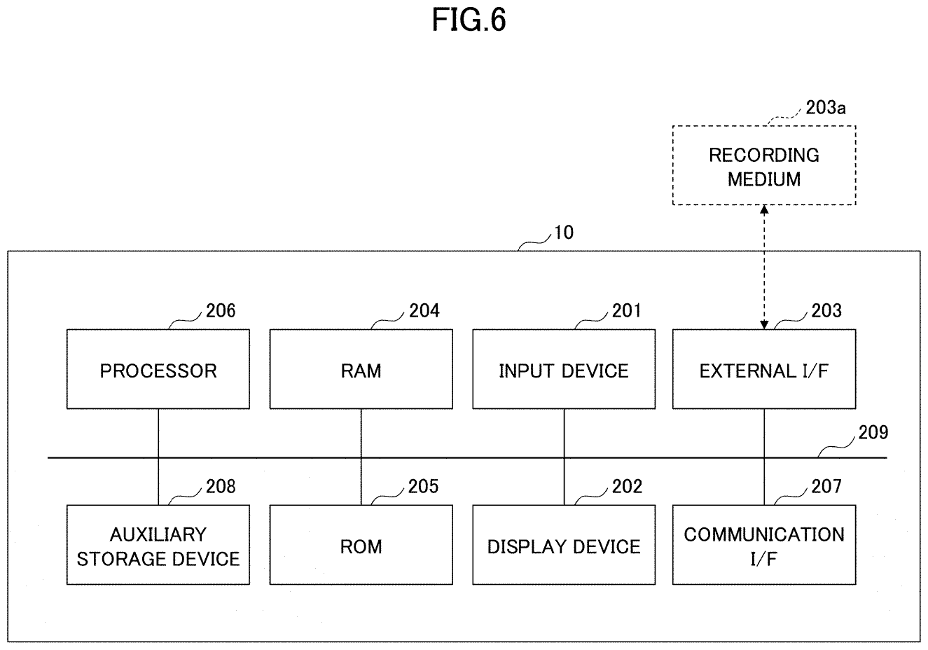

Next, a hardware configuration of the training device 10 according to the above-described embodiments will be described with reference to FIG. 6. FIG. 6 is a diagram illustrating an example of the hardware configuration of the training device 10 according to the embodiments.

As illustrated in FIG. 6, the training device 10 according to the embodiments includes, as hardware, an input device 201, a display device 202, an external I/F 203, a random access memory (RAM) 204, a read only memory (ROM) 205, a processor 206, a communication I/F 207, and an auxiliary storage device 208. Each of these hardware components is communicatively coupled through a bus 209.

The input device 201 is, for example, a keyboard, a mouse, a touch panel, or the like, and is used by a user to input various operations. The display device 202 may be, for example, a display or the like, and displays a processed result of the training device 10.

The external I/F 203 is an interface with an external device. The external device may be a recording medium 203a or the like. The training device 10 can read from or write to the recording medium 203a through the external I/F 203. Examples of the recording medium 203a include a flexible disk, a compact disc (CD), a digital versatile disk (DVD), a secure digital (SD) memory card, and a universal serial bus (USB) memory card.

The RAM 204 is a volatile semiconductor memory that temporarily stores programs and data. The ROM 205 is a non-volatile semiconductor memory that stores programs and data even if the power is turned off. For example, the ROM 205 may store setting information related to an operating system (OS), setting information related to the communication network, and the like.

The processor 206 is, for example, a central processing unit (CPU), a graphics processing unit (GPU), and the like, and is an arithmetic device that reads programs and data from the ROM 205 or the auxiliary storage device 208 into the RAM 204 and executes a process. Each functional unit included in the training device 10 according to the embodiments is achieved by, for example, the process that one or more programs stored in the auxiliary storage device 208 cause the processor 206 to execute.

The communication I/F 207 is an interface that connects the training device 10 to the communication network. The training device 10 can communicate with other devices by wireless or wire through the communication I/F 207. The components of the training device 10 according to the embodiments may be provided on, for example, multiple servers located at physically remote locations connected through the communication network.

The auxiliary storage device 208 is, for example, a hard disk drive (HDD), a solid state drive (SSD), or the like, and is a non-volatile storage device that stores programs and data. The programs and data stored in the auxiliary storage device 208 include, for example, an OS and an application program that implements various functions on the OS.

The training device 10 according to the embodiments has the hardware configuration illustrated in FIG. 6, so that various processes described above can be achieved. In the example illustrated in FIG. 6, a case in which the training device 10 according to the embodiments is implemented by one device (i.e., a computer) is illustrated. However, the embodiment is not limited to this, and the training device 10 may be implemented by multiple devices (i.e., computers), for example. Additionally, a single device (i.e., a computer) may include multiple processors 206 and multiple memories (such as the RAM 204, the ROM 205, and the auxiliary storage device 208).

### SUMMARY

As described above, even if there are some errors (inaccuracy) in each labelled data in a training data set, the training device 10 according to the above-described embodiments can obtain the data predicting unit 101 that is a trained model having high prediction accuracy by using the training data set, if the above-described condition 1 to condition 4 are satisfied.

In the embodiments described above, semantic segmentation is assumed as an example of a task, but the disclosure can be applied to various other tasks. For example, the disclosure can be applied to various tasks, such as instance segmentation, object detection that detects objects in an input image, a posture estimation that estimates posture of objects in an input image, a pose estimation that estimates human poses in an input image, and a depth estimation that predicts the depth of each pixel in an RGB image being an input image. The input data is not limited to images, and the disclosure can be applied to a task that uses sound data as the input data, for example.

Additionally, an application may be performed, so that, for example, different images or different sounds are superimposed with each other, from a viewpoint of the error predicting unit 102 (or the error predicting unit 102 and the modifying unit 103) modifying the error in the labelled data to cause the labelled data to approach the true labelled data (that is, for example, aligning an answer represented by the labelled data with a true correct answer). Specifically, for example, in an augmented reality (AR) application or a mixed reality (MR) application, the error predicting unit 102 (or the error predicting unit 102 and the modifying unit 103) may superimpose a CG image on an actual image.

The data predicting unit 101 of the training device 10 according to the embodiments described above may be pretrained and prepared prior to the training described above. That is, for example, step S101 described above may be omitted.

Additionally, the trained predicting device or error predicting unit 102 according to the embodiments described above may be used alone or incorporated into another system or device.

Here, as described above, each of the functional units included in the training device 10 according to the embodiments described above is achieved by the process that one or more programs stored in the auxiliary storage device 208 cause the processor 206 to perform, but the embodiment is not limited to this. For example, at least some of the functional units may be implemented by a circuit such as a field-programmable gate array (FPGA) instead of or in conjunction with the processor 206. For example, at least some of the one or more programs may be stored in the recording medium 203a. Additionally, for example, some of the above-described functional units may be provided by an external service through a Web API or the like.

The disclosure is not limited to the embodiments specifically disclosed above, and various modifications and alterations can be made without departing from the scope of the claims.

What is claimed is:

1. A system, comprising:
a first neural network configured to calculate, based on input data, data indicative of a predicted result of a predetermined prediction task for the input data; and
a second neural network configured to calculate, based on the input data and labelled data corresponding to the input data, data related to error in the labelled data;
wherein at least one of the first neural network or the second neural network is trained by using at least both the data indicative of the predicted result calculated by the first neural network and the data related to the error in the labelled data calculated by the second neural network.

2. The system as claimed in claim 1, wherein the data related to the error in the labelled data is data indicative of degree of the error in the labelled data or modified labelled data of the labelled data.

3. The system as claimed in claim 1, wherein the at least one of the first neural network or the second neural network is trained based on predictive error, the predictive error being obtained based on a predetermined process using at least both the data indicative of the predicted result calculated by the first neural network and the data related to the error in the labelled data calculated by the second neural network.

4. The system as claimed in claim 3, wherein the predetermined process includes modifying either the data indicative of the predicted result or the labelled data by using the data related to the error in the labelled data, and obtaining, as the predictive error, error between the modified data indicative of the predicted result and the labelled data or error between the modified labelled data and the data indicative of the predicted result by using a predetermined error function.

5. The system as claimed in claim 1, wherein both the first neural network and the second neural network are trained by using at least both the data indicative of the predicted result calculated by the first neural network and the data related to the error in the labelled data calculated by the second neural network.

6. The system as claimed in claim 1, wherein the training of the first neural network and the second neural network includes updating model parameters of the first neural network and the second neural network.

7. The system as claimed in claim 1, wherein the trained second neural network calculates, based on another input data and another labelled data corresponding to the another input data, data related to error in the another labelled data corresponding to the another input data, the data related to the error in the another labelled data being used to modify the another labelled data corresponding to the another input data.

8. The system as claimed in claim 1,
wherein the input data is image data or intermediate representation data of the image data, and
wherein the predetermined prediction task is semantic segmentation, instance segmentation, object detection that detects an object in the image data, a posture estimation that estimates posture of the object in the image data, a pose estimation that estimates a human pose in the image data, or a depth estimation that predicts a depth of each pixel in the image data.

9. The system as claimed in claim 1, wherein each of the first neural network and the second neural network is a convolutional neural network.

10. A training device comprising:
at least one memory; and
at least one processor configured to:
output data indicative of a predicted result from input data by using a first prediction model implemented by a first neural network;
output, based on labelled data corresponding to the input data, information indicating error in the labelled data by using a second prediction model implemented by a second neural network, the error in the labelled data being a difference between the labelled data and true labelled data;
generate modified labelled data that is obtained by modifying the labelled data based on the information indicating the error in the labelled data; and
train at least one of the first neural network or the second neural network based on predictive error between the data indicative of the predicted result and the modified labelled data.

11. The training device as claimed in claim 10, wherein the at least one processor simultaneously trains the first neural network and the second neural network.

12. The training device as claimed in claim 11,
wherein the at least one processor performs a first training, and performs a second training after the first training, the first training including training the first neural network and the second neural network by using a first learning coefficient of a parameter updating equation of the first neural network and a second learning coefficient of a parameter updating equation of the second neural network, the first learning coefficient being set greater than the second learning coefficient, and the second training including training the first neural network and the second neural network by changing at least one of the first learning coefficient or the second learning coefficient so that a difference between the first learning coefficient and the second learning coefficient in the second training is less than a difference between the first learning coefficient and the second learning coefficient in the first training.

13. The training device as claimed in claim 12,
wherein the at least one processor performs a third training and the second training after the first training, the third training including training the first neural network and the second neural network by changing at least one of the first learning coefficient or the second learning coefficient so that the second learning coefficient is greater than the first learning coefficient.

14. A training device comprising:
at least one memory; and
at least one processor configured to:
output, by using a neural network, data indicative of a predicted result corresponding to input data and modified labelled data corresponding to both of the input data and labelled data corresponding to the input data; and
train at least a part of the neural network based on the data indicative of the predicted result and the modified labelled data.

15. The training device as claimed in claim 14, wherein the at least one processor is configured to calculate an error based on at least the data indicative of the predicted result and the modified labelled data, and train at least the part of the neural network based on the error.

16. The training device as claimed in claim 14, wherein the at least one processor is configured to:
output the data indicative of the predicted result corresponding to the input data by using at least a first neural network included in the neural network;
output the modified labelled data corresponding to both of the input data and the labelled data by using at least a second neural network included in the neural network.

17. A training device comprising:
at least one memory; and
at least one processor configured to:
output data indicative of a predicted result from input data by using a first prediction model implemented by a first neural network;
output, based on labelled data corresponding to the input data, information indicating error in the labelled data by using a second prediction model implemented by a second neural network, the error in the labelled data being a difference between the labelled data and true labelled data;
generate modified data indicative of the predicted result that is obtained by modifying the data indicative of the predicted result based on the information indicating the error in the labelled data; and
train at least one of the first neural network or the second neural network based on predictive error between the modified data indicative of the predicted result and the labelled data.

18. A training method comprising:
outputting data indicative of a predicted result from input data by using a first prediction model implemented by a first neural network;
outputting, based on labelled data corresponding to the input data, information indicating error in the labelled data by using a second prediction model implemented by a second neural network, the error in the labelled data being a difference between the labelled data and true labelled data;
generating modified labelled data that is obtained by modifying the labelled data based on the information indicating the error in the labelled data; and
training at least one of the first neural network or the second neural network based on predictive error between the data indicative of the predicted result and the modified labelled data.

19. A predicting device comprising:
at least one memory; and
at least one processor configured to:
output data indicative of a predicted result from input data by using a first prediction model implemented by a first neural network;
wherein the predicted result is modified based on the data indicative of the predicted result and modified labelled data, the modified labelled data being generated by modifying labelled data corresponding to input data for training based on information indicating error in the labelled data, the error in the labelled data being a difference between the labelled data and true labelled data, and the information indicating the error in the labelled data being output based on the labelled data by using a second prediction model implemented by a trained second neural network.
